(19) United States
(12) Patent Application Publication
(10) Pub. No.: US 2020/0133026 A1
(43) Pub. Date: Apr. 30, 2020

(54) READING GLASSES AND GOGGLES WITH INTERCHANGEABLE LENSES

(71) Applicant: KAI FANG, Wenzhou City (CH)

(72) Inventor: KAI FANG, Wenzhou City (CH)

(21) Appl. No.: 16/233,101

(22) Filed: Dec. 27, 2018

(30) Foreign Application Priority Data
Oct. 31, 2018 (CH) 201811284985.X

(51) Int. Cl. G02C 7/08; G02C 5/02; G02C 5/22

(52) U.S. Cl. CPC G02C 7/086; G02C 5/2281; G02C 5/02

(57) ABSTRACT

The device is directed to a reading glasses and goggles having lenses of different strengths and functions which can be replaced by users themselves, comprising single lens side ring, a bracket, a connecting rod, an upper eyeglass frame and a connecting block, and specifically having a second fixture slot in the top of said single lens side ring; a groove in the bottom of said upper eyeglass frame; the outer surface of the second fixture slot being engaged with the inner wall of the groove. The reading glasses and goggles having lenses of different strengths and functions can be replaced by users themselves, having lenses of different strengths and functions.

### CROSS REFERENCE TO RELATED APPLICATIONS

Not applicable

### STATEMENT REGARDING FEDERALLY SPONSORED RESEARCH OR DEVELOPMENT

Not applicable

### FIELD OF THE INVENTION

The present invention pertains to the field of glasses technology, involving reading glasses and goggles with lenses of different strengths and functions which can be replaced by users themselves.

### BACKGROUND OF THE INVENTION

It is a problem in the art to provide reading glasses and goggles having lenses of different strengths and functions which can be replaced by users themselves, thereby eliminating the need to seek professional customization.

The glasses and the lenses embedded in the frame are worn in front of the eyes to improve vision, protect eyes or for decorative purposes. The glasses are composed of lenses and frames, including myopia glasses, hyperopia glasses, reading glasses and astigmatism glasses. There are also special glasses for watching 3D stereoscopic images or virtual real images. Other types of glasses include goggles, sunglasses, swimming goggles, etc., in order to provide eyes with various protections.

Currently, a pair of reading glasses with different strengths on the left and right lenses is not purchasable online. It can only be customized in the optical shop, which brings much inconvenience to the consumers. It is impossible for internet shoppers to purchase protective lenses with different strengths and functions according to different requirements, let alone to replace lenses by themselves.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a device for reading glasses and goggles having lenses of different strengths and functions which can be replaced by users themselves, characterized by a single lens side ring with lens which can be bought and assembled by the user simply and conveniently.

In order to achieve the above-mentioned object, the present invention provides the following technical solutions: The reading glasses and goggles having lenses of different strengths and functions can be replaced by users themselves, including single lens side ring, bracket, connecting rod, upper eyeglass frame and connecting block.

There is the second fixture slot in the top of said single lens side ring and a groove in the bottom of said upper eyeglasses frame. The outer surface of the second fixture slot is engaged with the inner wall of the groove. There is a fixing block on one end of said upper eyeglass frame and said fixing block and the connecting rod are screwed by a screw. One end of said connecting rod is fixed and connected to one end of the fixture block; a first fixture slot in one end of the said bracket; and inner side of the first fixture slot engaged with the outer surface of the fixture block.

Preferably, there are two single side rings, for left and right lenses.

Preferably, the inner wall of said single lens side ring is provided with lens.

Compared to prior art, advantageous effects of the present invention are: The present invention enables users to purchase a single lens side ring with a lens and replace the lens by themselves to suit their own different purposes and different demands on their vision strengths. It not only meets the requirements of the reader users for different strengths of the lenses on both sides, but also users with normal vision who want to change the glasses for different functions when using electronic devices or on various other occasions. Thereby, being easy to operate and convenient, there's no need to customize glasses in the local store.

A reading glasses device in which lenses of different strengths and functions can be replaced by users themselves, comprises:

a single lens side ring adapted for receiving a lens;

a bracket;

a connecting rod;

an upper eyeglass frame adapted to be connected to said connecting rod;

a connecting block supporting said connecting rod, said connecting block being adapted to connect said bracket to said upper eyeglass frame;

a top of said single lens side ring having a fixture slot;

said upper eyeglass frame having a bottom, said bottom of said upper eyeglass frame having a groove therein adapted to receive said single lens side ring; said groove having an inner wall;

said fixture slot of said single lens side ring having an outer surface, said outer surface of said fixture slot being engaged with said inner wall of said groove;

said upper eyeglass frame having a fixing block on one end;

a screw for connecting said fixing block and said connecting rod;

said connecting block having a fixture block;

one end of said connecting rod being fixed and connected to one end of said fixture block;

said bracket having a first fixture slot in one end; and

said first fixture slot having an inner side; said fixture block having an outer surface; and

said inner side of said first fixture slot being engaged with said outer surface of said fixture block.

The reading glasses device includes a plurality of lenses of different strengths and functions are provided which can be replaced by users themselves, further comprising a second single lens side ring; wherein said system thereby comprises two single lens side rings, for left and right.

The reading glasses device includes a plurality of lenses of different strengths and functions which can be replaced by users themselves, wherein said single lens side ring has an inner wall adapted to support a lens; and further comprising a lens connected to said inner wall of said single lens side ring.

A reading glasses system in which lenses of different strengths and functions can be replaced by users themselves comprises:

an upper glasses frame having a left end and a right end, said left end having a fixing block having a threaded portion; said upper glasses frame having an underside having a groove; said groove having an inner wall;

a connecting block having a first end and a second end, said first end of said connecting block having a fixture block and said second end of said connecting block having a connecting rod; said connecting rod having a hole therein;

a screw for insertion into said hole in said connecting rod and into said threaded portion of said fixing block for securing said connecting rod to said fixing block;

a bracket having a first fixture slot, said first fixture slot receiving said fixture block of said connecting block, for connecting said bracket to said upper glasses frame;

a single lens side ring adapted for carrying a lens, said single lens side ring having a second fixture slot; said second fixture slot of said single lens side ring having an outer surface, said outer surface of said fixture slot being engaged with said inner wall of said groove to connect said single lens side ring to said upper glasses frame.

A reading glasses system wherein a plurality of lenses of different strengths and functions are provided which can be replaced by users themselves, further including a second single lens side ring; wherein said system thereby comprises two single lens side rings, for left and right.

A reading glasses system wherein a plurality of lenses of different strengths and functions are provided which can be replaced by users themselves, and further comprising a lens connected to said inner wall of said single lens side ring.

A reading glasses system wherein said upper eyeglasses frame has a center portion, a left portion adapted to receive said single lens side ring, and a right portion adapted to receive another single lens side ring.

A reading glasses system wherein said single lens side ring has another second fixture slot, wherein there are two second fixture slots spaced apart.

A reading glasses system wherein said second fixture slot is formed on an upper portion of said single lens side ring, and wherein said single lens side ring has a nose piece member on one side.

### BRIEF DESCRIPTION OF THE DRAWINGS

FIG. 1 is an exploded top perspective view of the present invention.

FIG. 2 is a side perspective view of the present invention.

FIG. 3 is a front elevational view of the present invention.

FIG. 4 is a rear elevational view of the present invention.

FIG. 5 is a left elevational view of the present invention.

FIG. 6 is a right elevational view of the present invention.

FIG. 7 is a top plan view of the present invention.

FIG. 8 is a bottom plan view of the present invention.

FIG. 9 is a front view of the upper glasses frame disposed above a front view of the two single lense side rings of FIG. 1.

FIG. 10 is a perspective view from behind and below the view of FIG. 1, showing the assembly of the upper glasses frame with the left bracket and the right bracket.

FIG. 11 is a front view of the left single lens side ring with the attached respective lens.

FIG. 12 is a view of FIG. 11 as seen from the left of FIG. 11, showing the single lens side ring assembled with the lens.

FIG. 13 is a view of FIG. 11 as seen from the right of FIG. 11, showing the single lens side ring assembled with the lens.

FIG. 14 is a view of FIG. 11 as seen from the top of FIG. 11, showing the single lens side ring assembled with the lens.

FIG. 15 is a view of FIG. 11 as seen from the bottom of FIG. 11, showing the single lens side ring assembled with the lens.

FIG. 16 is a view as seen from the top of FIG. 15.

### DETAILED DESCRIPTION OF THE PREFERRED EMBODIMENT

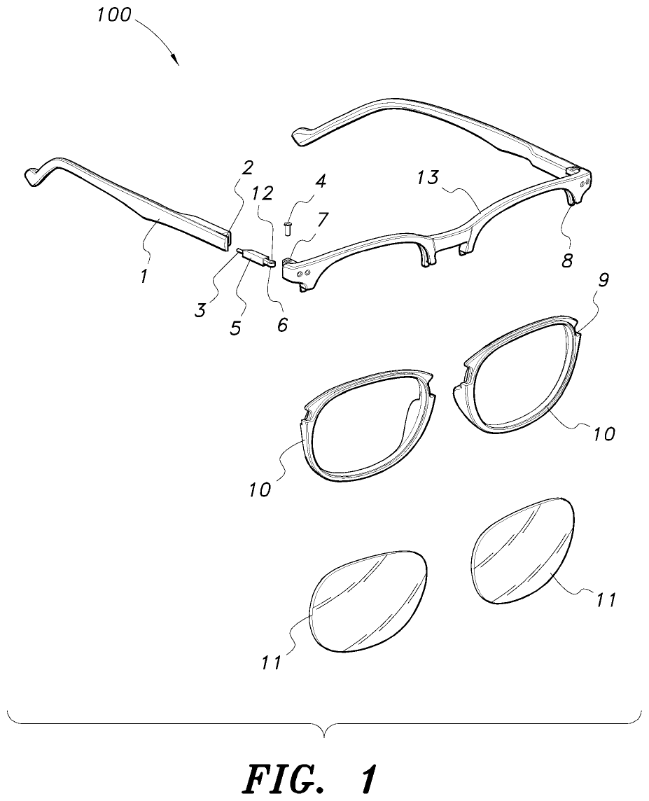

FIG. 1 is an exploded top perspective view of the present invention showing an eyeglass frame assembly 100 which includes an upper glasses frame 13, a bracket 1 having a first fixture slot 2, and a connecting block 5 having a first end having a fixture block 3 which is received within the first fixture slot 2. The connecting block 5 also has a second end having a connecting rod 6. The connecting rod 6 has a threaded hole 12 therethrough adapted to receive a screw 4. The upper glasses frame 13 has a left end (as viewed in FIG. 1) that has a fixing block 7 having a bore therein adapted to receive the screw 4. When assembled, the screw 4 thereby connects the upper glasses frame 13 to the connecting block 5 and the bracket 1. The upper glasses frame 13 has a central portion (unnumbered) which in use is disposed above the bridge of the nose of a wearer.

The parts described above are as numbered on the left side of FIG. 1, and there are similar parts (unnumbered) on the right side of FIG. 1 which are a mirror image of the parts shown on the left side.

FIG. 1 also shows two single lens side rings 10, 10 (also referred to below as first and second single lens side rings 10, 10, which are respectively on the left and right in this view). Each single lens side ring 10 has a fixture slot 9 (also referred to below as a second fixture slot 9). The second single lens side ring 10 is a mirror image of the first single lens side ring 10. The upper glasses frame 13 has a left side and a right side each respectively having a groove 8 on its underside for receiving a respective one of the single lens side rings 10, 10. Only one groove 8 is numbered in FIG. 1, on the right side in this view.

Each single lens side ring 10 is respectively secured to the upper glasses frame 13 in the respective groove 8. This securement can be done by any of the following methods: a snap-fit; a friction fit; adhesive or glue; and/or use of a pin or pins (not shown) received in the second fixture slot 9. This securement can also be accomplished in any other way which could be accomplished by any one having skill in the eyeglass frame art.

A pair of lenses 11, 11 are shown, which are respectively a first lens 11 and a second lens 11, which are respectively on the left and right sides in this view. Each of the first and second single lens side rings 10, 10 is adapted to hold a respective one of the lens 11, 11. The second lens 11 is a mirror image of the lens 11.

Each of the lens 11, 11 is respectively secured in the respective one of the first and second single lens side rings 10, 10. This securement can be done by any of the following methods: a snap-fit; adhesive or glue; and/or use of a pin or pins (not shown), tabs (not shown), or this securement can also be accomplished in any other way which could be accomplished by any one having skill in the eyeglass frame art.

The outer surface of the second fixture slot 9 is engaged with the inner wall of the groove 8.

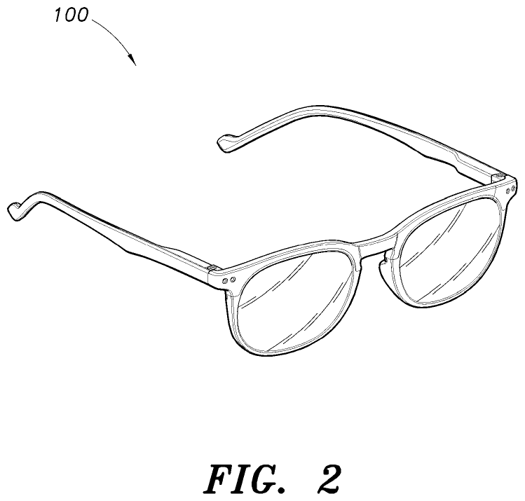

FIG. 2 is a side perspective view of the eyeglass frame assembly 100 of FIG. 1. In this view, the eyeglass frame assembly 100 is in a completely assembled form.

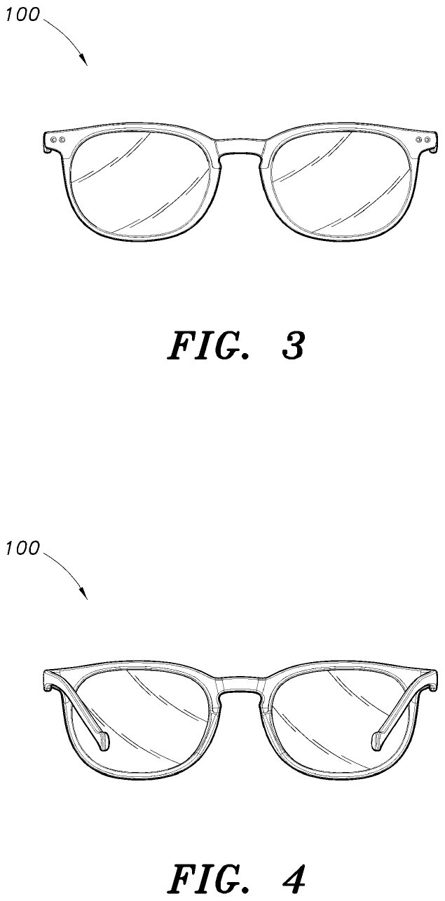

FIG. 3 is a front view of the eyeglass frame assembly 100 of FIG. 1.

FIG. 4 is a rear view of the eyeglass frame assembly 100.

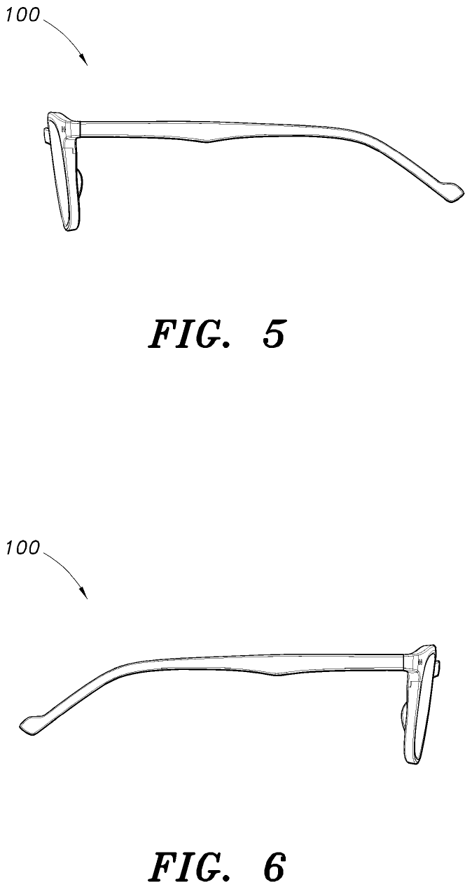

FIG. 5 is a left view of the eyeglass frame assembly 100.

FIG. 6 is a right view of the eyeglass frame assembly 100.

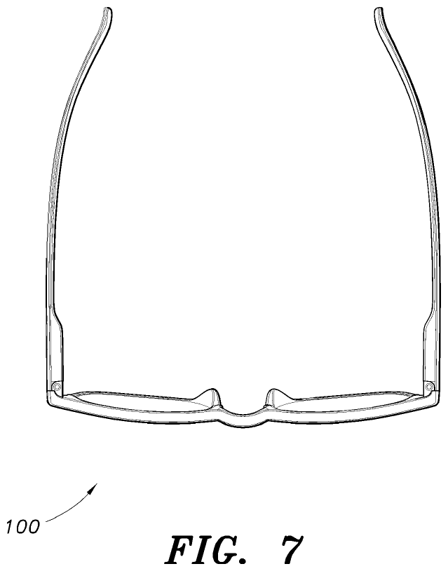

FIG. 7 is a top view of the eyeglass frame assembly 100.

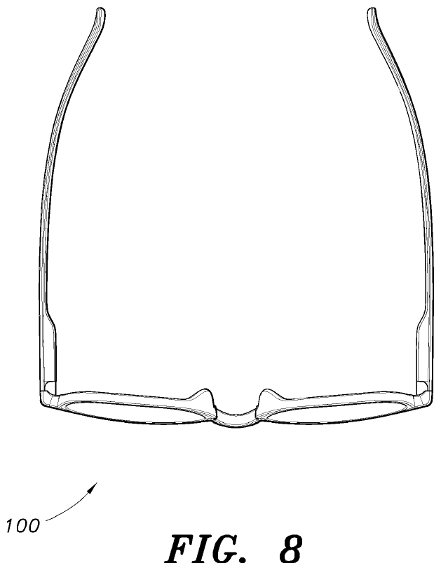

FIG. 8 is a bottom view of the eyeglass frame assembly 100.

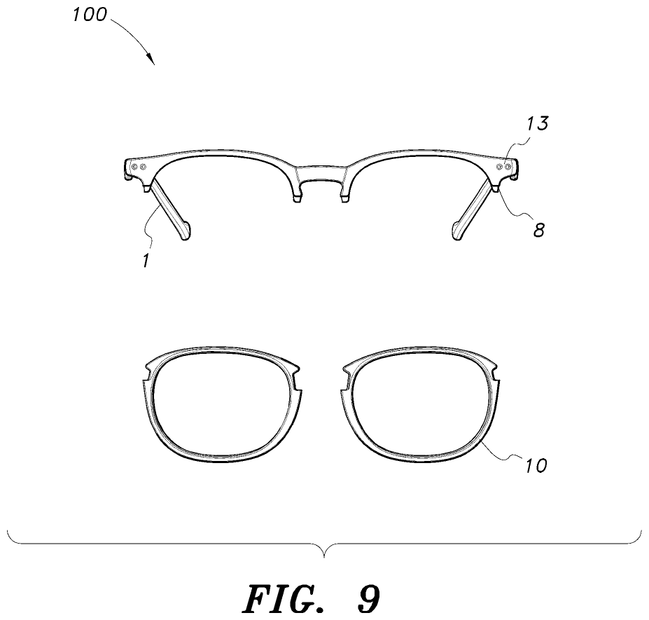

FIG. 9 is a front view of the upper glasses frame 13 disposed above a front view of the two single lense side rings 10, 10 of FIG. 1.

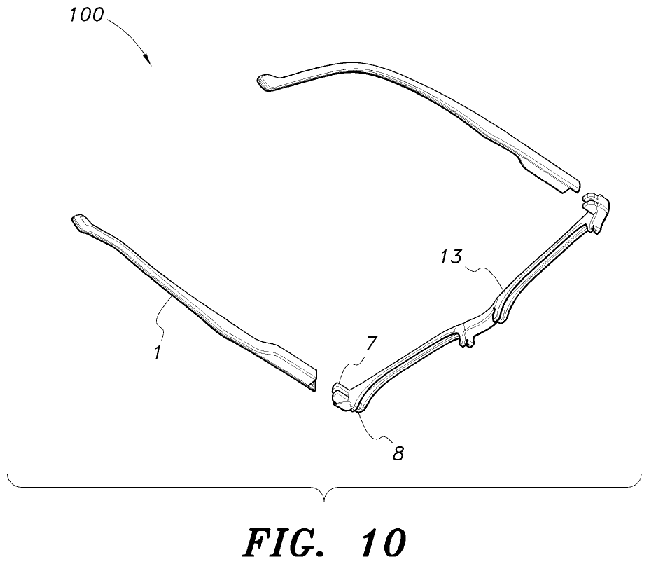

FIG. 10 is a perspective view from behind and below the view of FIG. 1, showing the assembly of the upper glasses frame 13 with the left bracket 1 and the right bracket (unnumbered). The (unnumbered) right bracket is a mirror image of bracket 1. This view shows the underside of the upper glasses frame 13 which clearly shows the fixing block 7 and the groove 8.

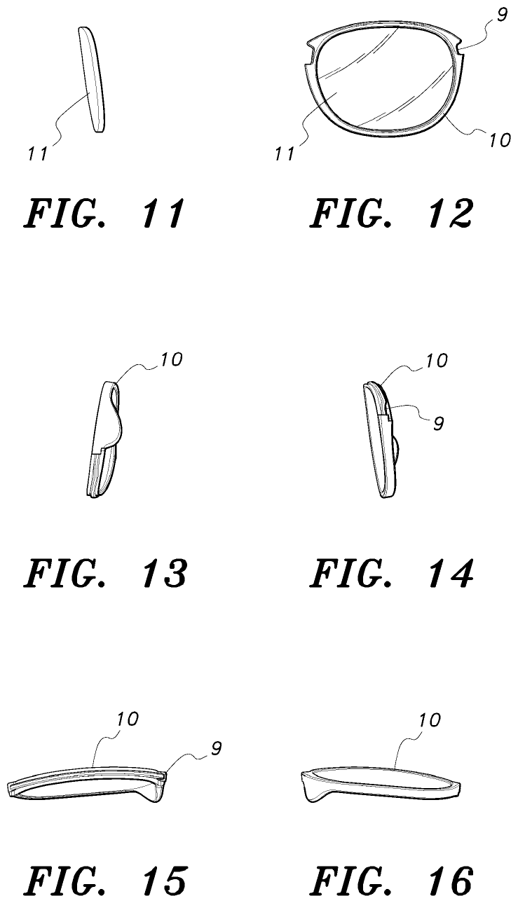

FIG. 11 is a front view of the left single lens side ring 10 with the attached respective lens 11. This view clearly shows the second fixture slot 9. A similar fixture slot (unnumbered) is shown on the left side of the single lens side ring 10.

FIG. 12 is a view of FIG. 11 as seen from the left of FIG. 11, showing the single lens side ring 10 assembled with the lens 11.

FIG. 13 is a view of FIG. 11 as seen from the right of FIG. 11, showing the single lens side ring 10 assembled with the lens 11.

FIG. 14 is a view of FIG. 11 as seen from the top of FIG. 11, showing the single lens side ring 10 assembled with the lens 11.

FIG. 15 is a view of FIG. 11 as seen from the bottom of FIG. 11, showing the single lens side ring 10 assembled with the lens 11.

FIG. 16 is a view as seen from the top of FIG. 15.

Referring to FIGS. 1-11 and FIGS. 12-16, the present invention provides the following technical solutions: The reading glasses and goggles having lenses of different strengths and functions which be replaced by users themselves, having the single lens side ring 10, the bracket 1, the connecting rod 6, the upper eyeglass frame 13 and the connecting block 5. The second fixture slot 9 is in the top of said single lens side ring 10; the groove 8 is in the bottom of said upper eyeglass frame 13. The outer surface of the second fixture slot 9 is engaged with the inner wall of the groove 8. The arrangement of said groove 8 and the second fixture slot 9 conforms to the mechanical setting, which is convenient for the user to disassemble. There is a fixing block 7 on one end of said upper eyeglass frame 13. The fixing block 7 and the connecting rod 6 are screwed by a screw 4, and one end of the connecting rod 6 is fixed and connected to one end of the fixture block 3. There is the first fixture slot 2 in one end of said bracket 1. The bracket 1 is arranged to contact the user's ear with the bracket 1 and support and fix the entire upper frame 13. The bracket 1 is in contact with the user's ears to support and fix the entire upper frame 13. The inner side of the first fixture slot 2 is engaged with the outer surface of the fixture block 3.

Specifically, there are two single side rings 10, 10, for left and right lenses 11, 11.

Specifically, the inner wall of said single lens side ring 10 is provided with the lens 11. Users can purchase the single lens side ring 10 with the lens 11, which is simple and convenient.

How the present invention works and is used: the user buys a single lens side ring 10 with the lens 11 online (or at a retail outlet in person) and then can make the second fixture slot 9 of single lens side ring 10 engaged with the groove 8 of the upper glasses frame 13, so that the replacement of different lenses is done by the user/purchaser. The same method is adopted for protective lens replacement in different occasions, so that the lens 11 can be replaced as appropriate.

Examples of use include: replacement of normal distant viewing lenses with reading lenses, or with protective (shatter resistant) lenses for industrial use, or tinted lenses for outdoor use, or polarized lenses for outdoor use; or other prescription strengths for intermediate viewing such as for working at computer screens; or for bipolar lenses; or multi-zone lenses have multiple zones for reading, computer, and distance viewing; and so on.

Finally, it should be noted that the above-mentioned is just a preferred embodiment of the present invention and not intended to limit the present invention. Although the present invention has been described in detail with reference to said embodiment, for those skilled in the art, technical solutions described in the said embodiment can be modified and any technical features can be equivalently replaced. Any modifications, equivalent substitutions, improvements, etc. made within the spirit and scope of the present invention are intended to be included within the scope of the present invention.

What is claimed is:

1. A reading glasses device in which lenses of different strengths and functions can be replaced by users themselves, comprising:
a single lens side ring adapted for receiving a lens;
a bracket;
a connecting rod;
an upper eyeglass frame adapted to be connected to said connecting rod;
a connecting block supporting said connecting rod, said connecting block being adapted to connect said bracket to said upper eyeglass frame;
a top of said single lens side ring having a fixture slot;
said upper eyeglass frame having a bottom, said bottom of said upper eyeglass frame having a groove therein adapted to receive said single lens side ring; said groove having an inner wall;
said fixture slot of said single lens side ring having an outer surface, said outer surface of said fixture slot being engaged with said inner wall of said groove;
said upper eyeglass frame having a fixing block on one end;
a screw for connecting said fixing block and said connecting rod;
said connecting block having a fixture block;
one end of said connecting rod being fixed and connected to one end of said fixture block;
said bracket having a first fixture slot in one end; and
said first fixture slot having an inner side; said fixture block having an outer surface; and
said inner side of said first fixture slot being engaged with said outer surface of said fixture block.

2. A reading glasses device as claimed in claim 1, wherein a plurality of lenses of different strengths and functions are provided which can be replaced by users themselves, further comprising a second single lens side ring; wherein said system thereby comprises two single lens side rings, for left and right.

3. A reading glasses device as claimed in claim 2, wherein a plurality of lenses of different strengths and functions are provided which can be replaced by users themselves, wherein said single lens side ring has an inner wall adapted to support a lens; and further comprising a lens connected to said inner wall of said single lens side ring.

4. A reading glasses system in which lenses of different strengths and functions can be replaced by users themselves, comprising:
an upper glasses frame having a left end and a right end, said left end having a fixing block having a threaded portion; said upper glasses frame having an underside having a groove; said groove having an inner wall;
a connecting block having a first end and a second end, said first end of said connecting block having a fixture block and said second end of said connecting block having a connecting rod; said connecting rod having a hole therein;
a screw for insertion into said hole in said connecting rod and into said threaded portion of said fixing block for securing said connecting rod to said fixing block;
a bracket having a first fixture slot, said first fixture slot receiving said fixture block of said connecting block, for connecting said bracket to said upper glasses frame;
a single lens side ring adapted for carrying a lens, said single lens side ring having a second fixture slot; said second fixture slot of said single lens side ring having an outer surface, said outer surface of said fixture slot being engaged with said inner wall of said groove to connect said single lens side ring to said upper glasses frame.

5. A reading glasses system as claimed in claim 4, wherein a plurality of lenses of different strengths and functions are provided which can be replaced by users themselves, further comprising a second single lens side ring; wherein said system thereby comprises two single lens side rings, for left and right.

6. A reading glasses system as claimed in claim 5, wherein a plurality of lenses of different strengths and functions are provided which can be replaced by users themselves, and further comprising a lens connected to said inner wall of said single lens side ring.

7. A reading glasses system as claimed in claim 4, wherein said upper eyeglasses frame has a center portion, a left portion adapted to receive said single lens side ring, and a right portion adapted to receive another single lens side ring.

8. A reading glasses system as claimed in claim 4, wherein said single lens side ring has another second fixture slot, wherein there are two second fixture slots spaced apart.

9. A reading glasses system as claimed in claim 4, wherein said second fixture slot is formed on an upper portion of said single lens side ring, and wherein said single lens side ring has a nose piece member on one side.
